(19) United States
(12) Patent Application Publication
(10) Pub. No.: US 2026/0291098 A1
(43) Pub. Date: Sep. 24, 2026

(54) SPRING-LOADED LEAD FRAME CONNECTORS

(71) Applicant: Nvidia Corporation, Santa Clara, CA (US)

(72) Inventors: Karl Joseph Bois, Fort Collins, CO (US); Michael David Herring, Apex, NC (US); Joseph Michael Gallo, Littleton, MA (US); Kevin Darrel Conn, Mointgomery, TX (US); Cong Gao, Pflugerville, TX (US); Arturo Pachon Munoz, San Jose, CA (US); Gabriele Gorla, Santa Clara, CA (US); Ryan Albright, Beaverton, OR (US); Trevor Mitchell, Santa Clara, CA (US)

(21) Appl. No.: 19/378,732

(22) Filed: Nov. 4, 2025

Related U.S. Application Data
(60) Provisional application No. 63/774,580, filed on Mar. 19, 2025.
(60) Provisional application No. 63/791,249, filed on Apr. 18, 2025.

(51) Int. Cl. H01R 12/73; H01R 13/03; H01R 43/26

(52) U.S. Cl. CPC H01R 12/737; H01R 13/03; H01R 43/26

(57) ABSTRACT

Systems and methods disclosed herein are for a connector having a lead section and a barrel section. The barrel section may be formed from a portion of the lead section and may include a pin and a spring. The pin may extend from or retract into the barrel section based in part on an interface with the spring. The pin may contact a surface contact pad on a circuit board to pass signals from the circuit board through the connector.

### CROSS-REFERENCE TO RELATED APPLICATION(S)

This is a non-provisional application that is related to and that claims the benefit of priority from U.S. provisional patent application Ser. No. 63/791,249, filed Apr. 18, 2025, and entitled “LEAD FRAME CONNECTORS FOR DATACENTER,” and U.S. provisional patent application Ser. No. 63/774,580, filed Mar. 19, 2025, and entitled “SPRING-LOADED LEAD FRAME CONNECTORS,” the entire contents of both of which are incorporated by reference herein and form a part of this specification for all intents and purposes.

### TECHNICAL FIELD

At least one aspect herein pertains generally to circuit board connectors and specifically pertains to spring-loaded connections within circuit board connectors.

### BACKGROUND

A lead frame connector may be a bridge for signals and other connections that may be used between circuit boards, such as between daughter boards or cards and backplanes or midplanes of a rack in a datacenter.

### BRIEF DESCRIPTION OF THE DRAWINGS

Various embodiments in accordance with the present disclosure will be described with reference to the drawings, in which:

FIG. 1A illustrates different lead frame connectors having a lead section and a barrel section, in accordance with at least one embodiment;

FIG. 1B illustrates cross section views of a lead frame connector having a lead section and a barrel section, in accordance with at least one embodiment;

FIG. 1C illustrates process details of a barrel section having a pin and a spring, in accordance with at least one embodiment;

FIG. 1D is a perspective view of an angled feature to allow a 90-degree angle of separation between the barrel sections of a connector that is part of a lead frame connector, in accordance with at least one embodiment;

FIG. 1E is a side view of an angled feature to allow a 90-degree angle of separation between the barrel sections of a connector that is part of a lead frame connector, in accordance with at least one embodiment;

FIG. 1F is an excerpt view of a connector having retracted pins in its barrel sections, in accordance with at least one embodiment.

FIG. 1G illustrates a cross-sectional excerpt view of a connector having retracted pins and compressed springs in its barrel sections, in accordance with at least one embodiment;

FIG. 2A illustrates a connection to be between two circuit boards and used for differential signaling by a lead frame connector, in accordance with at least one embodiment.

FIG. 2B illustrates a connector between a daughter card and a backplane or a midplane, in accordance with at least one embodiment;

FIG. 3 illustrates a process or method for a connector having a lead section and a barrel section, in accordance with at least one embodiment;

FIG. 4 illustrates an example datacenter to apply at least one embodiment for power connection in FIGS. 1-3 and 5-7;

FIG. 5 illustrates aspects of an example rack to apply at least one embodiment in FIGS. 1-4 and 6A-7;

FIG. 6A illustrates an example datacenter system, according to at least one embodiment;

FIG. 6B is a block diagram that schematically illustrates a computing system that may be a datacenter or a High-Performance Computing (HPC) cluster, in which at least one embodiment described herein may be used;

FIG. 6C illustrates a computer system, according to at least one example, in which at least one embodiment described herein may be used; and

FIG. 7 illustrates an example network configuration of components that can be used to implement aspects of various embodiments, such as to provide, generate, modify, encode, process, fuse, and/or transmit generated image data, calculated measurements, or other such content.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A lead frame connector may be a bridge connector that may be used between circuit boards (also referred to herein as printed circuit boards (PCBs)). The PCBs may be daughter cards and backplanes or midplanes of a rack in a datacenter. The lead frame connector may include an array of connectors. Each of the connectors may include a lead section and a barrel section. The barrel section may be formed from a portion of the lead section. The barrel section may include a pin and a spring. The pin is to extend from or retract into the barrel section based in part on an interface with the spring. Each connector having such a pin and a spring may be a single pogo pin feature of the lead frame connector. The pogo pin may be in reference to the pin configured or adapted to extend from or retract into the barrel section, which retains its communication capabilities for power and signals. The pin may be to contact a surface contact pad on a circuit board to pass signals from the circuit board and through the connector. As used herein, a surface contact pad may be a conductive area on the PCB or may be a lead from a component of the PCB designed to electrically connect to other components internally or externally, with respect to the PCB. A lead frame connector may include multiple ones of the parallel configuration of connectors in the array of connectors or in another similar format.

The parallel configuration of connectors may include at least two connectors providing differential signals. Each of a pair of two connectors may be within an enclosure or other structure to support connection to a pair of surface contact pads. The connector may include a stamped lead frame segment forming the lead section. A width of the end of the connector may be suitable or predetermined to allow the end to be formed into a cylinder or a barrel and referred to herein as a barrel section of the connector. The pin may be inserted through the barrel and interfaced with the spring that is also inserted into the barrel. A portion of the top of the barrel may be folded over an opening of the barrel to prevent the spring from exiting the barrel from the top. The pin may be compressed from the bottom and the bottom of the barrel may be rolled inward to also prevent the pin from being ejected once the pin has depressed the spring. This provides the barrel section of the connector. The connector may be used against surface contact pads of a backplane or a midplane, along with other similar connectors.

A problem addressed is that copper-based signal and power interconnect (connectors) may include pins that may be compliant interfaces which anchor into a PCB. The anchoring may be performed by plating through-hole or compression pins that mate to surface contact pads. In each case, the insertion or compression force of these schemes are high. In addition, compression pins may require a fixture to apply constant force to the connector so that the pins remain in contact with a surface of the PCB having surface contact pads. There may be sockets that may be inserted in between a connector, which provide a spring interface, but these may require an additional interface between the connector and the PCB.

The solution here uses a lead frame connector which includes direct integration of the spring-loaded pins as part of a lead frame connector's internal structure-the lead section and the barrel section formed from a portion of the lead section which may prevent damage to the midplane pins, and which may reduce the risk of costly rework or replacement in the field for any aspect of the lead frame connector. In addition, the solution uses a lead frame connector with an ability to use a single connector to connect two boards in a right-angle topology, which may be one possible example which uses a two-piece male and female connector without additional interface components. There may be straight-through connectors that may be also supported by the lead frame connector described here.

With respect to at least differential signaling, this may be in reference to communication or transmission of information using complementary signals over two separate conductors. In the present lead frame connectors may represent the separate conductors. On a receiver side, a difference between the complementary signals may be used to recover the information associated with the communication or transmission. The lead frame connector herein may be used for the differential signaling with traces on a circuit board by connections between the pins and the surface contact pads of the traces. The lead frame connector may be used with differential pair conductors in a cable. For example, the lead frame connector may be used between the cable and the circuit board or between computing components with the cable used between two lead frame connectors.

In some examples, one or more of the pins herein may be of different length and may allow a ground to connect first, prior to the pins making contact for signaling. For example, the pins may be of different length, relative to at least a pin or a ground reference. The pins may be of a 1 mil (millimeter) and 1.5 mil difference in length from the ground reference, compared to the pins for the signals. The pins may allow provide a presence signal prior to the differential signals using the remaining pins. The one or more pins for the presence signal may make contact before or after all the remaining pins make contact or before all the remaining pins make contact.

In one example, the complementary signals may include information which is transmitted on the separate conductors of the lead frame connectors, with opposite polarities. When one of the separate conductors uses a positive voltage swing, another may use a negative voltage swing of the same magnitude. The magnitude may be in reference to common-mode voltage. Differential signaling through the lead frame connectors provides advantages of improved immunity to noise which may include electromagnetic interference or crosstalk. The noise may be an issue with respect to individual ones of the separate conductors. As the information is only in a difference between the signals, the common-mode noise may cause little to no issue on the signals. Differential signaling, when used with the lead frame connectors, may support signal integrity and noise immunity for High-Speed (HS) communications, USB (Universal Serial Bus®), HDMI (High-Definition Multimedia Interface®), Ethernet®, PCI Express® (PCIe), SATA (Serial ATA), NVlink®, InfiniBand® (IB), and LVDS (Low-Voltage Differential Signaling).

The systems and methods described herein may be used for a variety of purposes, by way of example and without limitation, for machine control, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, datacenter processing, conversational artificial intelligence (AI), generative AI with large language models (LLMs), light transport simulation (e.g., ray-tracing, path tracing, etc.), collaborative content creation for 3D assets, cloud computing and/or any other suitable applications.

Disclosed examples herein may be comprised in a variety of different systems such as, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a datacenter, systems for performing conversational AI operations, systems for performing generative AI operations using LLMs, systems for performing light transport simulation, systems for performing collaborative content creation for 3D assets, systems implemented at least partially using cloud computing resources, and/or other types of systems.

In one example, computing devices benefiting from the lead frame connectors herein may include processors of different types. The processors may include central processing units (CPUs), graphics processing units (GPUs), data processing units (DPUs), quantum processing units (QPUs), parallel processing units (PPUs), and application-specific integrated circuits (ASICs). QPUs may be configured to perform one or more operations associated with a quantum algorithm. In some examples, each of the one or more QPUs may include qubits. One or more QPUs may be in communication with each other via a quantum channel. In some examples, each of the qubits may include local qubits, global qubits, and/or synchronization qubits. In some examples, the local qubits of each QPU may be configured to perform the one or more operations associated with the quantum algorithm on the QPU that are associated with the local qubits.

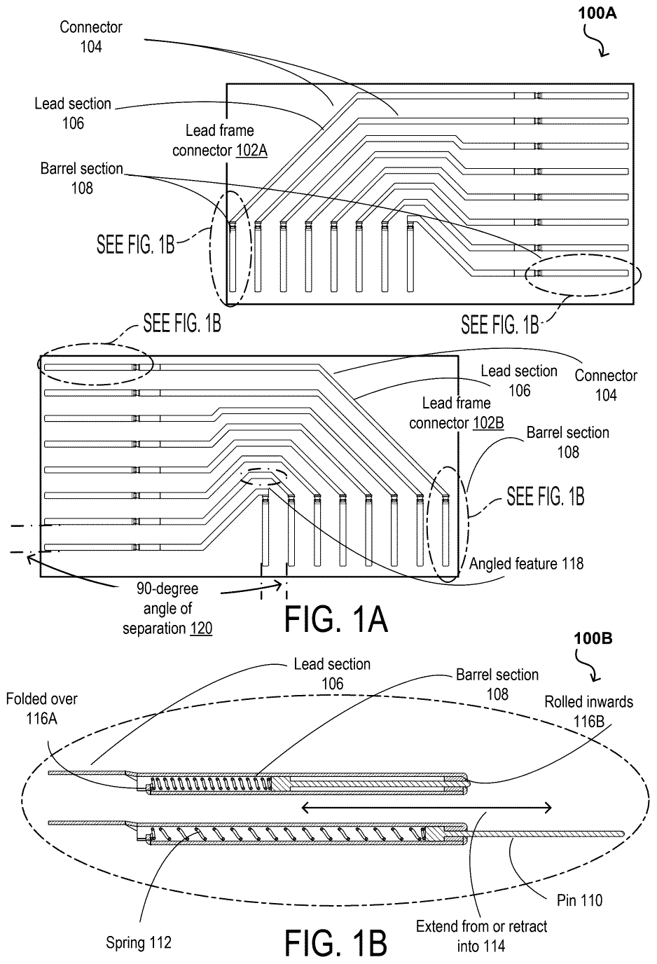

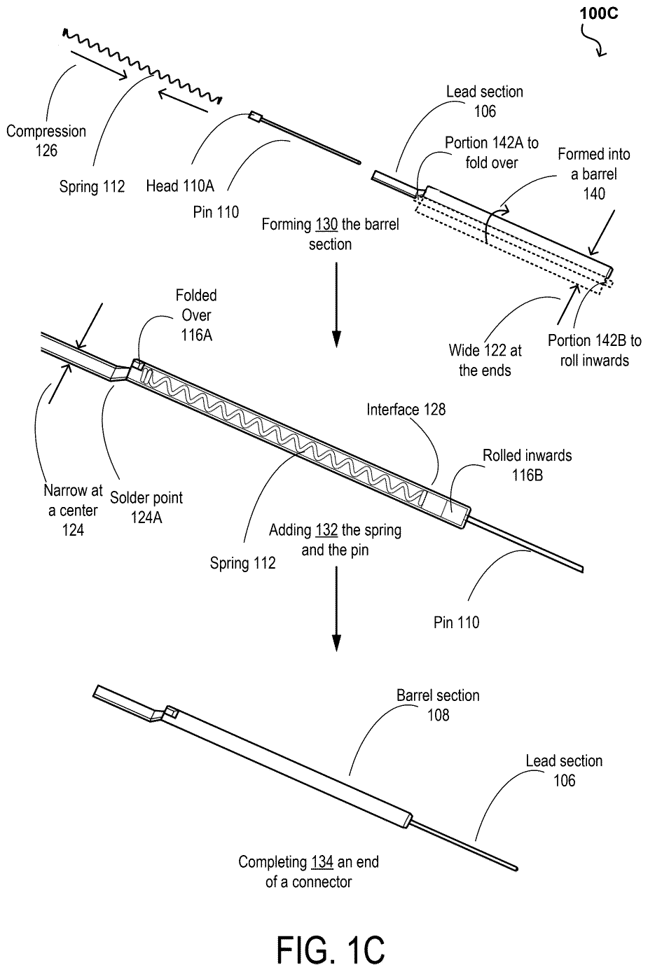

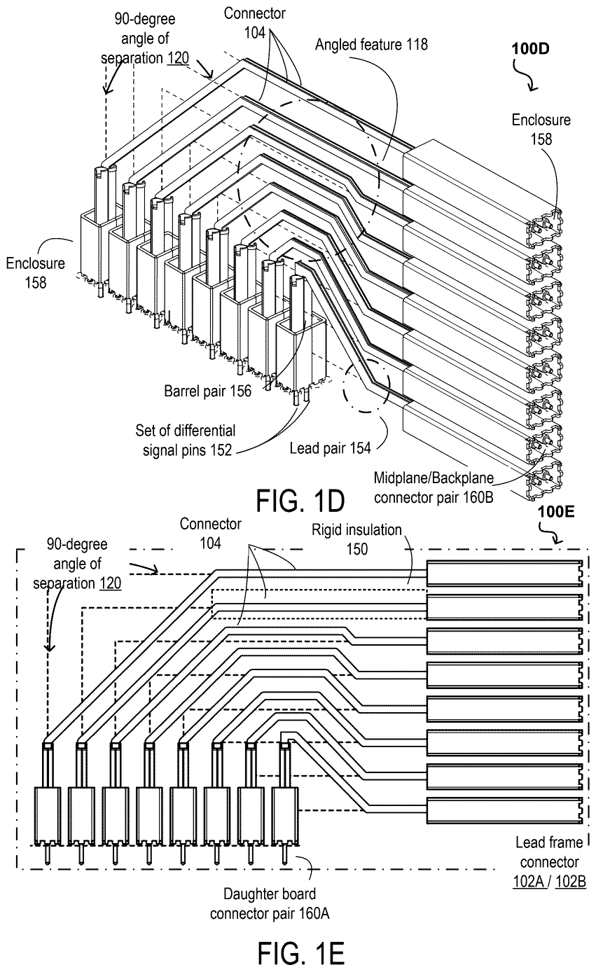

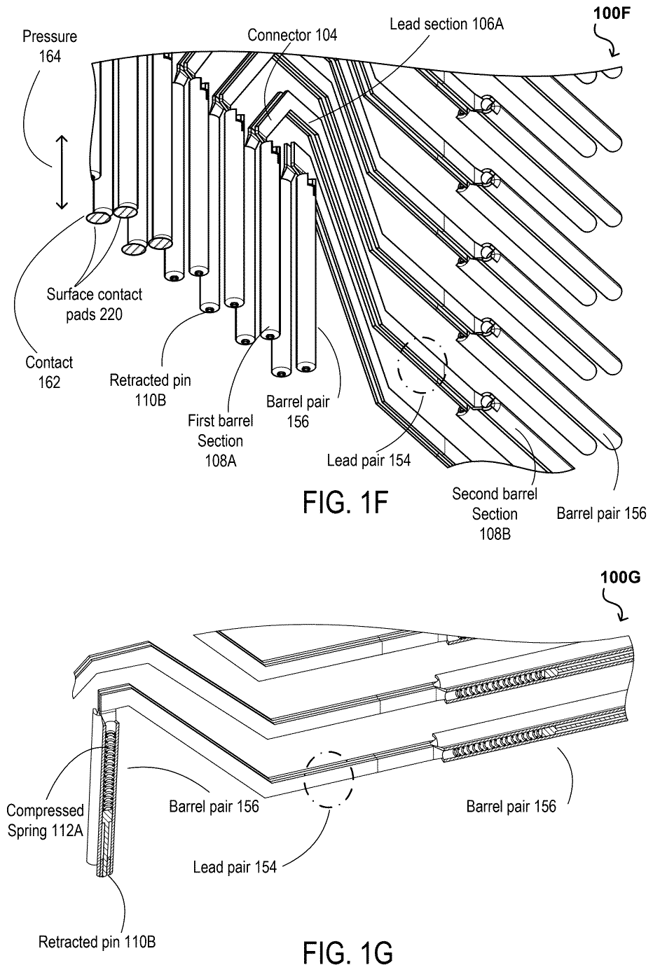

FIG. 1A illustrates different lead frame connectors 100A having a lead section and a barrel section, in accordance with at least one embodiment. In one example, each lead frame connector 102A, 102B may include a series of connectors 104. Each connector 104 may include a lead section 106 and a barrel section 108. The barrel section 108 may be formed from a portion of the lead section 106 (as illustrated and described in connection with FIG. 1C, for instance). The barrel section 108 may include a pin and a spring, as illustrated and described in connection With FIGS. 1B, 1C, for instance.

FIG. 1A also illustrates that the barrel section 108 may include a barrel formed from the lead section 106. In one example, the lead section 106 may be part of a strip of material having wider portions at its ends. The material may be 0.05 mm thick along its longest length and with a length suitable to reach opposite ends of a lead frame connector 102A, 102B at its longest length. The material may be wide 122 at both ends of the longest length and may be narrow 124, relative to the width 122, at a center of the longest length. The material may include one or more of a copper alloy or nickel plating. The pin may be formed by one or more of a copper alloy or gold plating. The spring may be formed from stainless steel. All such materials are conductive. The barrel section 108 may allow an electrical connection from the pin and through the barrel section to pass the signals or power, from the circuit board, through the connector.

FIG. 1A also illustrates that each lead section 108 may include an angled feature 118. The angled feature may include one or more angles therein, as illustrated. The angled feature 118 may be to allow a 90-degree angle of separation 120 between the barrel sections 108 of the same connectors 104 and another barrel section of another connector, as illustrated. The one or more angles may be provided to enable a suitable traversal of multiple lead sections within a space available for the lead frame connector 102A, 102B.

FIG. 1B illustrates cross section views 100B of a lead frame connector having a lead section and a barrel section, in accordance with at least one embodiment. The wider portions, as described with respect to FIG. 1A and illustrated in FIG. 1C, may be folded into the barrel. In addition, the strip of material having the wider portions may include portions at a top and at a bottom of the barrel. The portion at the top of the barrel may be folded over 116A at an opening of the barrel to prevent the spring 112 from exiting the barrel from the top. The pin 110 (such as in FIG. 1B) may be compressed from the bottom of the barrel. The portion at the bottom of the barrel may be folded or rolled inward 116B to also prevent the pin from being ejected once the pin is depressed. This provides the barrel section 108 of the connector 104. The connector 104 may be used against surface contact pads of a backplane or a midplane, along with other similar connectors, as detailed further in FIGS. 1B-7.

FIG. 1C illustrates process details 100C of a barrel section having a pin and a spring, in accordance with at least one embodiment. As illustrated, a first step may include forming 130 the barrel section 108 using a width of material that is narrow 124 at the center and that is wide 122 at its ends. The wide 122 material may be suitable or predetermined to allow the ends to be formed into a barrel, as part of the forming 130 step. The process details 100C illustrate that a step of adding 132 the spring and the pin may be performed. The pin 110 and the spring 112 may be inserted through a top or a bottom of the barrel with a head 110A of the pin 110 to interface 128 with the spring 112. The spring may have a compression 126 capability to allow the insertion into the barrel.

A portion 142A of the top of the barrel may be folded over 116A an opening of the barrel once the spring 112 is inserted to prevent the spring 112 from exiting the barrel from the top. The pin 110 may be separately provided from a bottom of the barrel and may be provided to compress the spring from the bottom. A portion 142B of the bottom of the barrel may be rolled inwards 116B to also prevent the pin 110 from being ejected once the pin 110 has depressed the spring 112. This completes 134 or provides the barrel section 108 of the connector 104. The connector 104 may be used against surface contact pads of a backplane or a midplane, along with other similar connectors, as detailed with respect to one or more of FIGS. 1D-7. The barrel section 108 formed may be soldered via solder point 124A to lead section 106, when the barrel section 106 is formed separately from the lead section 106, in some examples.

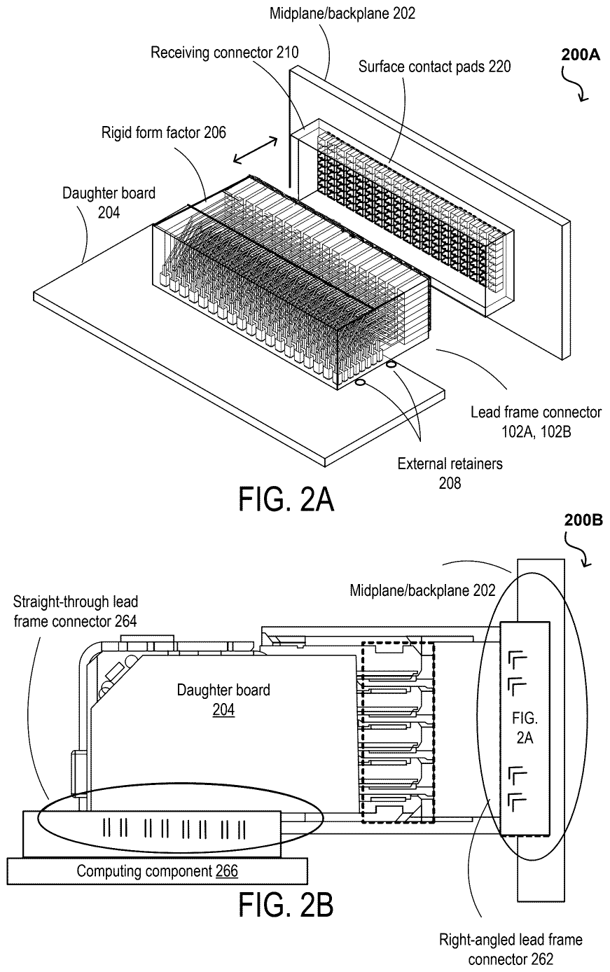

FIG. 1D is a perspective view 100D of an angled feature to allow a 90-degree angle of separation between the barrel sections of a connector that is part of the lead frame connectors, in accordance with at least one embodiment. FIG. 1D illustrates that there may be a set of connectors 104 running together, as part of a differential signal connection, with at least two pins 110 being a set of differential signal pins 152. Each of the connectors may be part of an array of connectors, such as the 1-dimensional (1D) array illustrated, but capable of supporting at least 2-dimensional (2D) arrays, as illustrated in at least FIG. 2A. The 1D or 2D arrays may form a lead frame connector 102A, 102B that may be between a circuit board and a further circuit board or a computing component. Two connectors 104 may be aligned to form a pair of connectors having at least one barrel pair 156 and a lead pair 154. There may be at least two barrel pairs 156 for each lead pair 154, with each barrel pair 156 being on one end of the lead pair 154. In addition, the ends may be supported by angled features 118 which allow a 90-degree angle of separation 120 between the barrel sections 108 of the connectors 104.

Each connector 104 may be such that its lead section 106 may be part of a lead pair 154 and may include an insulation media between the lead pair 154. In one example, the insulation media may be air. In another example, a rigid insulation 150 may be provided around the lead section 106 and may extend over the barrel section 108. The rigid insulation 150 may allow a rigid form factor 206 for the connector and may allow a rigid form factor for the array of connectors to form a lead frame connector 102A, 102B. The lead section 106 may include the lead pair 154 in a formation of parallel leads. The parallel leads may have parallel barrels in the barrel section 108. In one example, the parallel barrels form a barrel pair 156, which may include a further pin and a further spring. The pins from the barrel pair 156 may be a set of different signal pins that are to support or allow a differential signal therebetween. FIG. 1D may include a 1D array of parallel leads (in the lead pair 154, for instance) to allow the connector 104 to be part of a lead frame connector 102A, 102B.

FIG. 1E is a side view 100E of an angled feature to allow a 90-degree angle of separation between the barrel sections of a connector that is part of a lead frame connector, in accordance with at least one embodiment. The 90-degree angle of separation 120 between the barrel sections 108 of individual connectors 104 allows a lead frame connector 102A, 102B to couple between circuit boards that are perpendicular to each other, between computing components that are perpendicular to each other, or between a circuit board and a computing component that are perpendicular to each other. The connectors 104 may include rigid insulation 150 throughout the lead sections 106, although a cage receptacle or an enclosure 158 that may include rigid insulation may be used. In addition, the enclosure 158 may guide connection between the lead frame connector 102A, 102B and a receiving connector, such as described with respect to at least FIG. 2A. In one example, a short enclosure 158 may support a connection between a lead frame connector 102A, 102B and a daughter card. The short enclosure 158 may include a daughter board connector pair 160A of pins. The long enclosure 158 (relative to the short enclosure) may support a connection between a lead frame connector 102A, 10B and a backplane or a midplane. The long enclosure 158 may include a midplane or backplane connector pair 160B of pins. The connector 104, in one example, is between a daughter board and a backplane or a midplane, which is detailed further with respect to at least FIG. 2A.

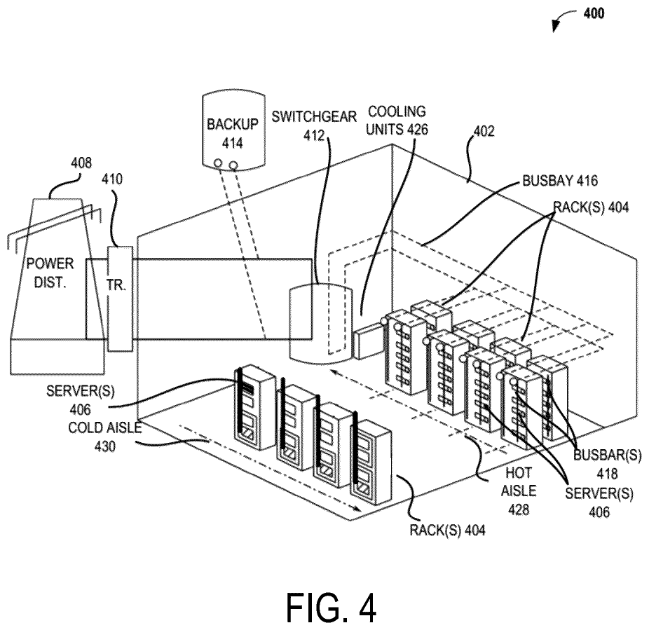

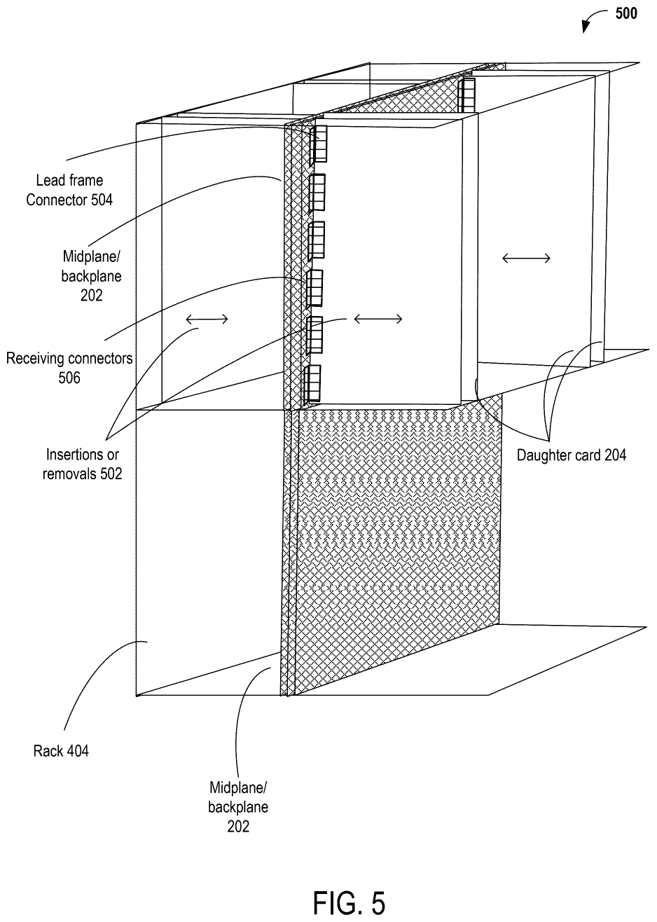

FIG. 1F is an excerpt view 100F of a connector having retracted pins in its barrel sections, in accordance with at least one embodiment. FIG. 1F illustrates that, when coupled against a circuit board or a computing component, the pins 110 may be in a retracted pin 110B position within the barrel section 108 of each barrel pair 156. FIG. 1F illustrates that the lead pair 154 and the barrel pair 156 may include air as insulation or a rigid insulation therebetween. In one example, the enclosures 158 may support a distance maintained between the connectors 104 in each of the lead pair 154 and the barrel pair 156. FIG. 1F also illustrates that there may be multiple of ones of the lead pair 154 and the barrel pair 156, based in part on the type of lead frame connector 102A, 102B. For example, the lead frame connector may communicate signals for different standards referenced throughout herein or may communicate power, as described in connection with at least FIGS. 4 and 5, in one example.

FIG. 1F also illustrates that, when a frame connector 102A, 102B of a daughter board is coupled to a receiving connector (such as in FIGS. 2A, 2B) of a midplane or a backplane 202 (also in FIGS. 2A, 2B), the pins 110 of the connectors 104 pass through the receiving connector and contact 162 surface contact pads 220 of the midplane or the backplane 202. The contact 162 includes a predetermine pressure 164 between the pins 110 and the surface contact pads 220 that may be sufficient to cause the retracted pin 110B position for each of the pins 110. The pressure 164 is also sufficient to ensure that the retracted pins 110B maintain electrical connectivity by the contact 162 so as to pass signals from the midplane or the backplane 202 and through each connector 104 of the lead frame connector 102A, 102B. FIG. 1F also illustrates a first barrel section 108A associated with a second barrel section 108B. The first barrel section 108A may be coupled, through the lead section 106A, to the second barrel section 108B. The first barrel section 108A may be coupled to a daughter board 204 (in FIG. 2A). The second barrel section 108B may be coupled to a midplane or a backplane 202 of a rack in a datacenter (such as in FIGS. 4 and 5).

The contact 162 avoids problems of the compliant interfaces which anchor into a PCB. The retracted pins 110B allow coupling and decoupling without through-hole or compression pins to mate to surface contact pads. In each case, the pins 110 capable of being in a retracted pin 110B position allows predetermined insertion or compression forces without damage or loss of contact after repeated coupling and decoupling using the lead frame connector 102A, 102B herein. In addition, the pins 110 capable of being in a retracted pin 110B position allows constant force, as part of the pressure 164, so that the pins 110 remain in contact with the surface contact pads 220. The lead frame connector 102A, 102B herein ensures that there need not be additional interfaces between each connector 104 and a circuit board, such as the midplane or the backplane 202.

FIG. 1G illustrates a cross-sectional excerpt view 100G of a connector having retracted pins and compressed springs in its barrel sections, in accordance with at least one embodiment. In one example, FIG. 1G illustrates a cross-section of the excerpt view 100F from FIG. 1F. FIG. 1G illustrates that, when coupled against a circuit board or a computing component, the pins 110 may be in a retracted pin 110B position within the barrel section 108 of each barrel pair 156 at least by a compression to a respective spring 112 so that the spring 112 is in a compressed spring 112A position.

FIG. 2A illustrates a connection 200A to be between two circuit boards and used for differential signaling by a lead frame connector, in accordance with at least one embodiment. One of the circuit boards may be a midplane or a backplane 202 and another one of the circuit boards may be daughter board 204. The lead frame connector 102A, 102B may include a rigid form factor 206 provided by at least rigid insulation that may be all throughout the lead sections 106 and one or more of the barrel sections 108 of individual connectors 104. As illustrated, the lead frame connector 102A, 102B may be held down by enclosures 158 of individual daughter board connector pairs 160A and of individual midplane or backplane connector pairs 160B. In another example, an external tie or other external retainers 208 may be used between the circuit boards and the lead frame connector 102A, 102B. The external tie or other external retainers 208 may function to retain or restrict the lead frame connector 102A, 102B from disconnection or movement away from a receiving connector 210 of a circuit board. On at least the daughter board 204, the receiving connector may be the surface contact pads and the external tie or other external retainers 208, in one example. On the midplane or the backplane, the surface contact pads 220 may be aligned with the receiving connector 210 and its associated enclosures 158 to allow a connection from a lead frame connector 202A, 202B. The pins 110 on the lead frame connector 202A, 202B is pressured or forced against the surface contact pads 220 at least by a bias from the springs 112.

FIG. 2B illustrates a connection 200B between a daughter card and a backplane or a midplane and other computing components, in accordance with at least one embodiment. FIG. 2B illustrates the use of a right-angled lead frame connector 262 between a daughter board 204 and a midplane or backplane 202. The right-angled lead frame connector 262 may be as described in connection with FIG. 2A, and specifically, as to the lead frame connector 102A, 102B in FIG. 2A. FIG. 2B also illustrates the use of a straight-through lead frame connector 264 having a straight lead section 106 and a straight barrel section 108 for each of its connectors 104. The straight-through lead frame connector 264 may be provided between computing components 266 and the daughter board 204. The computing components may be adapters, memory sticks, communication cards, and others that may be intended for use with a daughter card 204 or the midplane or backplane 202, through the daughter card 204. The straight-through lead frame connector 264 need not include the angled feature 118 in its individual connectors 104, in one example.

Each of the right-angled lead frame connector 262 and the straight-through lead frame connector 264 may include integration of the spring-loaded pins 110 as part of its lead frame connector's internal structure with a lead section 106 and with a barrel section 108 which is formed from a portion of the lead section, as discuss in detail with one or more of FIGS. 1A-1G. In at least one example, the pin 110 in each connector 104 of the right-angled lead frame connector 262 and the straight-through lead frame connector 264 may extend from or retract into 114 the barrel section 108 based in part on an interface 128 with the spring 112. The pin 110 is to contact a surface contact pad on a circuit board (that is either the daughter card 204 or the midplane or backplane 202, depending on the connection made). The contact may be to pass signals from the circuit board through the connector. In addition, each connector 104 may include a first barrel section to couple, through a lead section, to a second barrel section. Each conductor may be part of a conductor array of a lead frame connector and may be such that the first barrel section is coupled to a daughter board 204 and the second barrel section is coupled to a midplane or a backplane 202 of a rack in a datacenter, which is detailed further in at least FIG. 5.

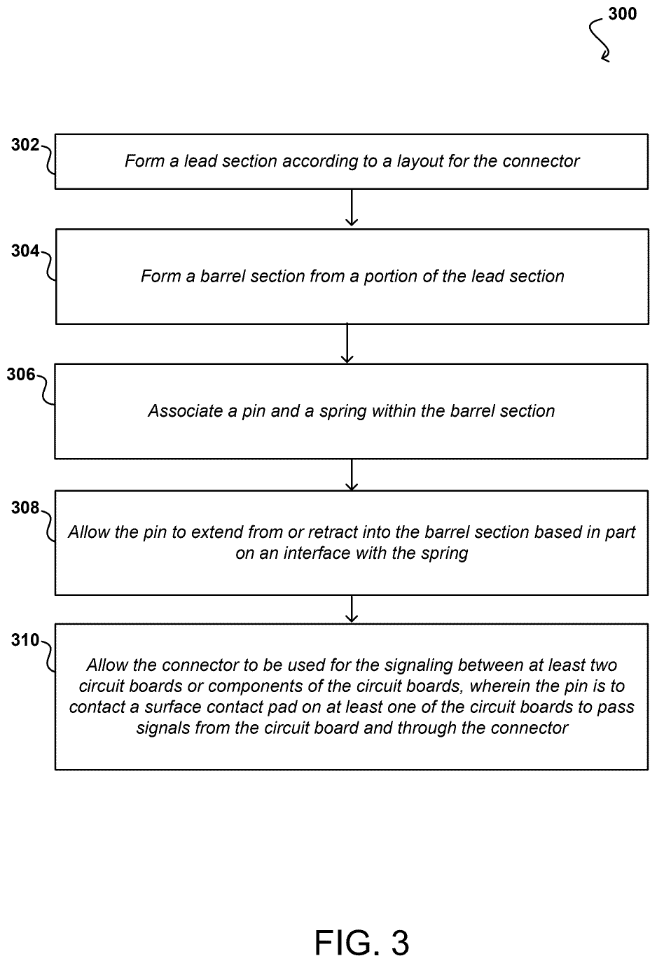

FIG. 3 illustrates a process or method 300 for a connector having a lead section and a barrel section, in accordance with at least one embodiment. For instance, the method 300 may include a step to form 302 a lead section according to a layout for the connector. The layout may be provided during design of the circuit boards, in one example. The layout may be provided during design of a rack, in another example. The layout may include distances and spaces available to the one or more circuit boards for coupling together and for use with cables or other computing devices, in one example. The method 300 may include a step to form 304 a barrel section from a portion of the lead section. The method 300 may include a step to associate 306 a pin and a spring within the barrel section. The method 300 may include a step to allow 308 the pin to extend from or retract into the barrel section based in part on an interface with the spring. The method 300 may include a step to allow 310 the connector to be used for the signaling between at least two circuit boards or components of the circuit boards. The pin may be to contact a surface contact pad on at least one of the circuit boards to pass signals from the circuit board and through the connector. In another example, the step to allow 310 the connector to be used may include usage in power connections between a source and to the circuit board.

FIG. 4 illustrates an example datacenter to apply at least one embodiment for power connection in FIGS. 1A-3 and 5-7. The datacenter 400 may include racks 404 that may be associated with servers 406 therein (in a server tray, server box, or server/computer module format), and that may include compute devices therein to perform a workload. Although illustrated as horizontal features, the servers 406 may be vertically provided within a rack 404. Such racks 404 may be tied (such as hardwired or natively within rows of racks) as part of the infrastructure of the datacenter 400. For instance, the racks 404 may be associated with power supply units (PSUs) and may be associated with a busbay 416 to receive and distribute power for the servers 406, these racks 404 may necessarily include power components (such as busbars 418) that are intimately associated with the racks 404. The power components may be part of the infrastructure of the datacenter 400. The racks 404 may include high-speed interconnect, enabling high-speed communication between subsystems, including the servers 406.

The compute devices may be provided on circuit boards and may include processors (such as central processing units (CPUs), quantum processing units (QPUs), graphics processing units (GPUs), data processing units (DPUs), application-specific integrated circuits (ASICs), field-programmable gate arrays (FPGAs), physics processing units (PPUs), or the like), and other components (such as memory, communication modules, input/output modules, and the like).

In at least one embodiment, the datacenter 400 may include one or more rooms 402 of racks 404, where the racks 404 may include server trays or servers 406. The datacenter 400 may be powered from a power distribution 408 system, via one or more transformers 410 (Tr.), so that the power to a switchgear 412 may be suitable for the datacenter. For instance, the power distribution 408 system may be part of a transmission system. The transmission system may provide high-voltage electricity from a utility grid. Each transformer 410 may step down the voltage to a level suitable for the datacenter's equipment and devices, such as the aforementioned processors that may be in the server trays or servers 406 in each rack 404. The switchgear 412 may be able to control, protect, and isolate power in both downstream and upstream directions.

The switchgear 412 may be used to manage flow of electricity in a reliable and efficient manner using switching of electrical circuits for controls and using breakers and fuses to detect and respond to faults or overloads in both downstream and upstream directions. In addition to an external source represented by the transmission systems and to ensure uninterrupted power supply, a backup 414 system, such as a generator or Uninterruptible Power Supply (UPS), may be used with the power distribution 408 system (Power Dist.). In addition, a cooling unit 426 may provide at least air cooling for the cold aisle 430 side and pass through the racks 404 to the hot aisle 428 side of the datacenter 400. The movement of the air cooling may be supported by fans, in one example.

The switchgear 412 may be associated with the busbay 416. The busbay 416 may provide power to one or more racks 404. In one example, the busbay 416 may provide power to one or more racks 404 through provided busbars 418. The busbars 418 may be conductive bars that carry electrical current to various loads, including those represented by the aforementioned processors, which may be within the server trays or computer modules (also referenced as servers 406) in each rack 404 of the datacenter 400. The busbars 418 may be provided from copper, aluminum, or a suitable power delivery material. The busbars 418 may be able to work together to handle the high-current demands of the datacenter 400.

The datacenter 400 may include a midplane or a backplane 202, as in FIGS. 2A, 2B, and the related discussions. The midplane or the backplane 202 may have the surface contact pads to receive the lead frame connectors 102A, 102B, 264, 266 (such as in FIGS. 1A and 2B) from other circuit boards (such as the daughter cards 204 in FIGS. 2A and 2B) or from other components of the datacenter. These components may include power components as described herein and the computing components 266, as described in connection with FIG. 2B, for instance. The midplane or the backplane 202 may be associated with receiving connectors 210 to receive lead frame connectors of the daughter boards 204, where multiple daughter boards 204 may be plugged into the midplane or backplane 202. The lead frame connectors may include individual connectors 104 with pins 110 and springs 112. The pins 110 may be to contact surface contact pads within the receiving connectors using the pins. The pins 110 and the surface contact pads may include a robust connection therebetween based in part on a spring bias from the springs 112 of the lead frame connectors on the surface contact pads of the receiving connectors and based in part on an alignment supported by the enclosures 158 and any rigid insulation 150 provided as part of the lead frame connectors 102A, 102B.

FIG. 5 illustrates aspects 500 of an example rack to apply at least one embodiment in FIGS. 1-4 and 6A-7. The aspects 500 illustrate that a rack 404 may have at least one circuit board that may be a midplane or a backplane 202. Although illustrated as open, the rack 404 may be fully enclosed with front, back, side, and top covers or access panels. Also, although illustrated at a high-level flat structure, the circuit board may include at least one PCB (also, as illustrated and described in at least FIGS. 2A and 2B). When used as a backplane, a circuit board may include a single side of receiving connectors 506 to receive lead frame connectors 504 of the daughter boards or cards 204. When used as a midplane, the circuit board may include two sides of receiving connectors 506 to receive lead frame connectors 504 of the daughter boards or cards 204 on both sides of the circuit board. In the aspects 500 in FIG. 5, the circuit board is a midplane which is located at a middle of a rack 404. The midplane may receive servers 406 in a vertical board format or daughter cards 204, which may be pushed for insertion 502 against the receiving connectors 506, for instance, of the midplane forming one or many connections between the midplane and the servers or the daughter cards 204.

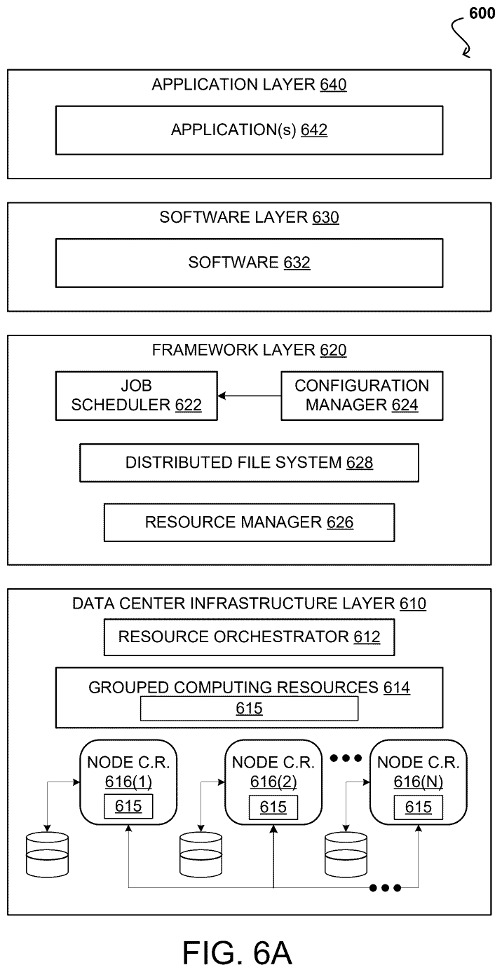

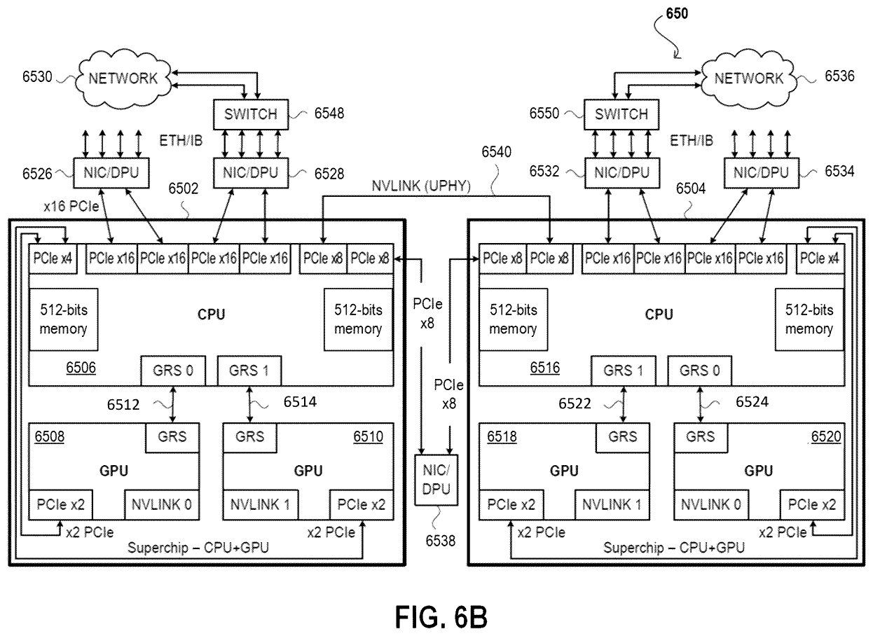

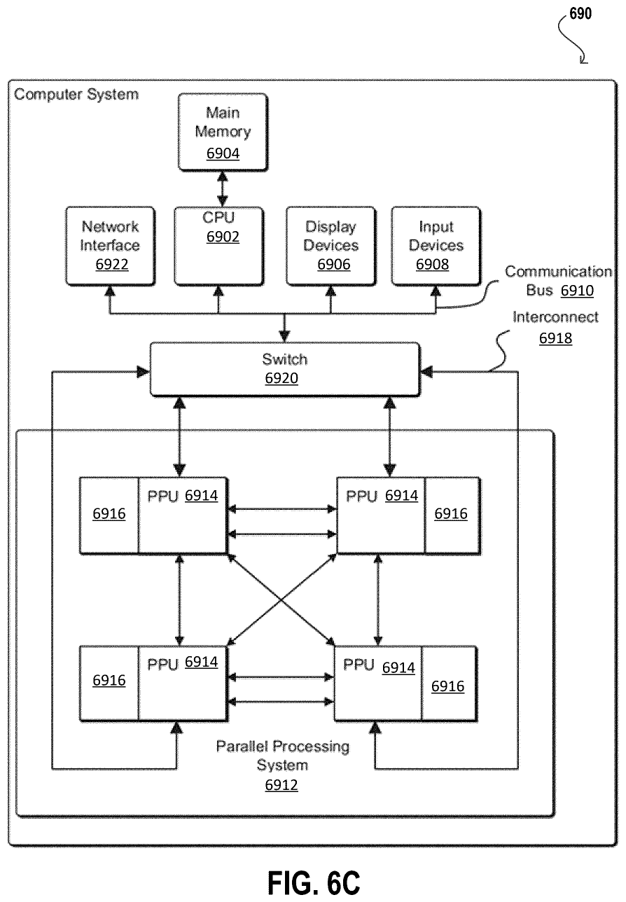

FIG. 6A illustrates an example datacenter 600, in which at least one embodiment may be used. In at least one embodiment, datacenter 600 includes a datacenter infrastructure layer 610, a framework layer 620, a software layer 630, and an application layer 640. FIG. 6A illustrates an example datacenter 600, in which at least one embodiment may be used. In at least one embodiment, datacenter 600 includes a datacenter infrastructure layer 610, a framework layer 620, a software layer 630, and an application layer 640. A datacenter 600 may include one or more racks, such as described in connection with at least FIGS. 1A and 1B. The racks may include one or more server trays. There may be one or more electronic components in the one or more server trays to perform at least part of a workload in the datacenter. The racks and server trays may be represented by at least the datacenter infrastructure layer 610. The electronic components may be presented by the node computing resources 616(1)-616(N) that may be subject to cooling using cold plates.

The datacenter 600 may include a cooling loop to remove heat from the electronic components during performance of the workload. The cooling loop may include a manifold with manifold modules and a lid as detailed in one or more of FIGS. 2A to 5D The lid may include a curved surface to be positioned within a passage of the manifold. The curved surface may be configured to receive and direct a flow of a cooling fluid away from a stagnant flow space within the manifold. The datacenter 600 may include multiple segment cooling loops to remove heat from the electronic components during performance of the workload. The segment cooling loops may include multiple manifold modules. Individual outlets of the manifold modules can direct a cooling fluid. Multiple lids at different ends of the plurality of manifold modules can reduce a flow velocity of the cooling fluid, by a predetermined threshold, at the individual outlets.

In at least one embodiment, as shown in FIG. 6A, datacenter infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 616(1)-616(N) may be a server having one or more of above-mentioned computing resources.

In at least one embodiment, grouped computing resources 614 may include separate groupings of node C.R.s housed within one or more racks (not shown), or many racks housed in datacenters at various geographical locations (also not shown). Separate groupings of node C.R.s within grouped computing resources 614 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 612 may configure or otherwise control one or more node C.R.s 616(1)-616(N) and/or grouped computing resources 614. In at least one embodiment, resource orchestrator 612 may include a software design infrastructure (“SDI”) management entity for datacenter 600. In at least one embodiment, resource orchestrator may include hardware, software or some combination thereof.

In at least one embodiment, as shown in FIG. 6A, framework layer 620 includes a job scheduler 622, a configuration manager 624, a resource manager 626 and a distributed file system 628. In at least one embodiment, framework layer 620 may include a framework to support software 632 of software layer 630 and/or one or more application(s) 642 of application layer 640. In at least one embodiment, software 632 or application(s) 642 may respectively include web-based service software or applications, such as those provided by Amazon Web Services, Google Cloud and Microsoft Azure. In at least one embodiment, framework layer 620 may be, but is not limited to, a type of free and open-source software web application framework such as Apache Spark™ (hereinafter “Spark”) that may use distributed file system 628 for large-scale data processing (e.g., “big data”). In at least one embodiment, job scheduler 622 may include a Spark driver to facilitate scheduling of workloads supported by various layers of datacenter 600. In at least one embodiment, configuration manager 624 may be capable of configuring different layers such as software layer 630 and framework layer 620 including Spark and distributed file system 628 for supporting large-scale data processing. In at least one embodiment, resource manager 626 may be capable of managing clustered or grouped computing resources mapped to or allocated for support of distributed file system 628 and job scheduler 622. In at least one embodiment, clustered or grouped computing resources may include grouped computing resource 614 at datacenter infrastructure layer 610. In at least one embodiment, resource manager 626 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 628 of framework layer 620. The one or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 628 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 624, resource manager 626, and resource orchestrator 612 may implement any number and type of self-modifying actions based on any amount and type of data acquired in any technically feasible fashion. In at least one embodiment, self-modifying actions may relieve a datacenter operator of datacenter 600 from making possibly bad configuration decisions and possibly avoiding underused and/or poor performing portions of a datacenter.

In at least one embodiment, datacenter 600 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 600. In at least one embodiment, trained machine learning models corresponding to one or more neural networks may be used to infer or predict information using resources described above with respect to datacenter 600 by using weight parameters calculated through one or more training techniques described herein.

In at least one embodiment, datacenter may use CPUs, application-specific integrated circuits (ASICs), GPUs, FPGAs, DPUs, QPUs or PPUs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 6A for inferencing or predicting operations based, at least in part, on weight parameters calculated using neural network training operations, neural network functions and/or architectures, or neural network use cases described herein.

FIG. 6B is a block diagram that schematically illustrates a computing system that may be a datacenter or a High-Performance Computing (HPC) cluster, in which at least one embodiment from FIGS. 1A-5D may be used. The computing system 650 may include a plurality of subsystems, e.g., multiple processing devices coupled to each other, multiple network devices, and multiple networks, according to at least one embodiment. The computing system 650 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 650 and to one or more external networks 6530, 6536. In the present example, computing system 650 comprises a packet switch 6548 that connects NIC/DPU 6528 to network 6530, and a packet switch 6550 that connects NIC/DPU 6532 to network 6536.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 650 can include one or more CPUs and one or more GPUs.

FIG. 6B also demonstrates an example architecture of a multi-GPU architecture. As illustrated in the figure, computing system 650 includes a processing device 6502 with a multi-GPU architecture. In particular, processing device 6502 may be a system-on-chip and includes multiple subsystems such as a CPU 6506, a GPU 6508, and a GPU 6510. CPU 6506 can be coupled to GPU 6508 via a die-to-die (D2D) or chip-to-chip (C2C) interconnect 6512, such as a Ground-Referenced Signaling interconnect (GRS interconnect). CPU 6506 can be coupled to GPU 6510 via a D2D or C2C interconnect 6514. CPU 6506 can also couple to GPU 6508 and GPU 6510 via PCIe interconnects.

CPU 6506 can be coupled to one or more NICs or DPUs, which are coupled to one or more networks. For example, as illustrated in FIG. 6B, CPU 6506 is coupled to a first NIC/DPU 6526, which is coupled to a network 6530. CPU 6506 is also coupled to a second NIC/DPU 6528, which is coupled to network 6530 via switch 6548. NIC/DPU 6526 and NIC/DPU 6528 can be coupled to network 6530 over Ethernet (ETH), NVLINK or InfiniBand (IB) connections, for example.

Computing system 650 also includes a processing device 6504 with a multi-GPU architecture. In particular, processing device 6504 includes multiple subsystems including a CPU 6516, a GPU 6518, and a GPU 6520. CPU 6516 can be coupled to GPU 6518 via a D2D or C2C interconnect 6522. CPU 6516 can be coupled to GPU 6520 via a D2D or C2C interconnect 6524. CPU 6516 can also couple to GPU 6518 and GPU 6520 via PCIe interconnects. CPU 6516 can be coupled to one or more NICs or DPUs, which are coupled to one or more networks. For example, as illustrated in FIG. 6B, CPU 6516 is coupled to a first NIC/DPU 6532, which is coupled to a network 6536. CPU 6516 is also coupled to a second NIC/DPU 6534, which is coupled to network 6536 via switch 6550. NIC/DPU 6532 and NIC/DPU 6534 can be coupled to network 6536 over Ethernet (ETH), NVLINK or InfiniBand (IB) connections.

In at least one embodiment, processing device 6502 and processing device 6504 can communicate with each other via a NIC/DPU 6538, such as over PCIe interconnects. Processing device 6502 and processing device 6504 can also communicate with each other over a high-bandwidth communication interconnects 6540, such as an NVLink interconnect or other high-speed interconnects. The packet switches in FIG. 6B may comprise, for example, Nvidia Quantum-2 switches. The NICs/DPUs in the figure may comprise, for example, Nvidia Bluefield DPUs.

In various embodiments, any of the network devices of the computing system 650, e.g., any of NICs/DPUs 6526, 6528, 6532, 6534 and 6538, and/or any of switches 6548 and 6550, may include a shaped leak sensor that can match a geometry around components and features in the computing system 650 and that can be communicatively coupled together to extend leak detection capabilities.

FIG. 6C illustrates a computer system, according to at least one example, in which at least one embodiment from FIGS. 1A-6B and 7 may be used. In at least one embodiment, computer system 690 is configured to implement various processes and methods described throughout this disclosure.

In at least one embodiment, computer system 690 comprises, without limitation, at least one central processing unit (“CPU”) 6902 that is connected to a communication bus 6910 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 690 includes, without limitation, a main memory 6904 and control logic (e.g., implemented as hardware, software, or a combination thereof) and data are stored in main memory 6904 which may take form of random access memory (“RAM”). In at least one embodiment, a network interface subsystem (“network interface”) 6922 provides an interface to other computing devices and networks for receiving data from and transmitting data to other systems from computer system 690.

In at least one embodiment, computer system 690, in at least one embodiment, includes, without limitation, input devices 6908, parallel processing system 6912, and display devices 6906 which can be implemented using a conventional cathode ray tube (“CRT”), liquid crystal display (“LCD”), light emitting diode (“LED”), plasma display, or other suitable display technologies. In at least one embodiment, user input is received from input devices 6908 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 6904 and/or secondary storage. Computer programs, if executed by one or more processors, enable system 690 to perform various functions in accordance with at least one embodiment. Main memory 6904, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 6902; parallel processing system 6912; an integrated circuit capable of at least a portion of capabilities of both CPU 6902; parallel processing system 6912; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 690 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 6912 includes, without limitation, a plurality of parallel processing units (“PPUs”) 6914 and associated memories 6916. In at least one embodiment, PPUs 6914 are connected to a host processor or other peripheral devices via an interconnect 6918 and a switch 6920 or multiplexer. In at least one embodiment, parallel processing system 6912 distributes computational tasks across PPUs 6914 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 6914, although such shared memory may incur performance penalties relative to use of local memory and registers resident to a PPU 6914. In at least one embodiment, operation of PPUs 6914 is synchronized through use of a command such as_syncthreads( ), wherein all threads in a block (e.g., executed across multiple PPUs 6914) to reach a certain point of execution of code before proceeding.

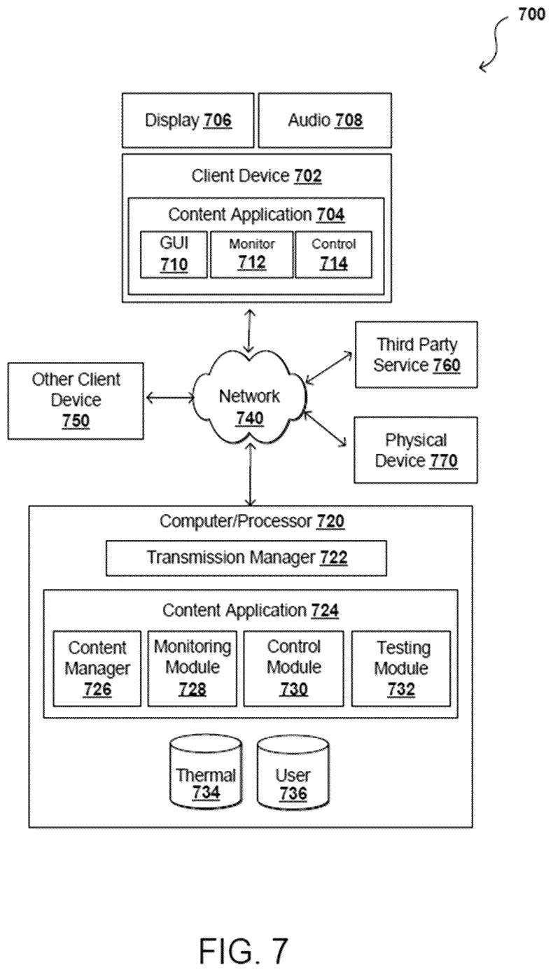

FIG. 7 illustrates an example network configuration 700 of components that can be used to implement aspects of various embodiments, such as to provide, generate, modify, encode, process, fuse, and/or transmit generated image data, calculated measurements, or other such content. In at least one embodiment, a client device 702 can generate or receive data for a session using components of a content application 704 on the client device 702 and data stored locally on that client device. In at least one embodiment, a content application 724 executing on a computer or processor 720 (e.g., a cloud server or control system) may initiate a session associated with at least one client device 702 (e.g., a vehicle or robot), as may use a session manager and user data stored in a user database 736, and can cause content such as liquid coolant or server thermal data to be selected and/or retrieved from a thermal repository 734 to be used by a testing module 732 to calculate one or more performance metrics for a monitoring module 728, which can provide flow data or thermal data to a control module 730 to control a flow or temperature, in an environment where the data is to be used to determine appropriate operation. A content manager 726 may work at these various modules to perform testing and analysis, and potentially instruct any actions to be taken in response to a performance metric failing to satisfy operational requirements. At least a portion of this data or instructional content can be transmitted to the client device 702 and/or a physical device 770 using an appropriate transmission manager 722 to send by download, streaming, or another such transmission channel. An encoder may be used to encode and/or compress at least some of this data before transmitting it to the client device 702. In at least one embodiment, the client device 702 receiving such content can provide this content to a corresponding content application 704, which may also or alternatively include a graphical user interface (GUI) 710, a flow monitor module 712, and a control module 714 for use in providing, synthesizing, rendering, compositing, modifying, or using content for presentation, navigation, control, (or other purposes) on or by the client device 702, such as may be transmitted to the physical device 770. In some embodiments, the computer/processor 720 and client device 702 may be able to communicate directly without needing to transmit data over a network 740, in order to avoid issues with latency and availability, etc. A decoder may also be used to decode data received over the network 740 for presentation via client device 702, such as imaging content or performance metrics through a display device 706 and audio, such as corresponding sounds or synthesized speech, through at least one audio playback device 708, such as speakers or headphones. In at least one embodiment, at least some of this content may already be stored on, rendered on, or accessible to client device 702 such that transmission over a network 740 is not required for at least that portion of content, such as where that content (e.g., thermal data) may have been previously downloaded or stored locally on a hard drive or optical disk. In at least one embodiment, a transmission mechanism such as data streaming can be used to transfer this content from the computer/processor 720, or user database 736, to the client device 702. In at least one embodiment, at least a portion of this content can be obtained, enhanced, and/or streamed from another source, such as a third-party service 760 or other client device 750, that may also include a content application for generating, updating, enhancing, or providing map content. In at least one embodiment, portions of this functionality can be performed using multiple computing devices, or multiple processors within one or more computing devices, such as may include a combination of CPUs and GPUs (Graphics Processing Unit).

In at least one embodiment, a cold plate herein may include adjustable fins forming microchannels for fluid to flow through. In at least one embodiment, fins in a cold plate allow transfer of heat from at least one associated computing device to a fluid flowing through microchannels formed between multiple fins. In at least one embodiment, fins of a cold plate are dynamically and adjustable in real time to allow transfer of more heat from at least one computing device to a fluid that flows through a cold plate having fins. In at least one embodiment, such fins may be adjusted by a processor or processorless system based in part on a temperature determined, such as sensed, for a cold plate. In at least one embodiment, a temperature may be associated with at least one computing device, a workload of at least one computing device, or a fluid at different time periods and at an entry, and at an egress of a cold plate. In at least one embodiment, a processorless system may rely on a thermal property of at least two materials used to form fins for a cold plate so that such fins may react without a processor to cause exposure of more surface area to a fluid. In at least one embodiment, such fins may include an overlapping portion that may be caused to be exposed by action of a control mechanism or by properties of at least two materials associated together to form a fin.

In at least some of these examples, client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a datacenter or server farm. In at least one embodiment, the request may be received or processed by at least one edge server, which sits on a network edge and is outside at least one security layer associated with the cloud provider environment. In this way, latency can be reduced by allowing the client devices to interact with servers that are in closer proximity, while also improving security of resources in the cloud provider environment.

In at least one embodiment, such a system can be used for monitoring or managing thermal conditions of a server which includes cold plates as liquid manifolds. In other embodiments, such a system can be used for other purposes, such as for providing control of liquid coolant flow, or for performing deep learning operations. In at least one embodiment, such a system can be implemented using an edge device or may incorporate one or more Virtual Machines (VMs). In at least one embodiment, such a system can be implemented at least partially in a datacenter or at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

The medium of transmission is any type of networking cable e.g., direct attach copper (DAC), active copper cable (ACC), active optical cables (AOCs), cable assembly with OSFP connectors or the like) or interconnect utilized by datacenter racks and associated switch modules (e.g., a Small Form Pluggable (SFP), quad small form-factor pluggable (QSFP), or the like). It may also be a passive copper cable (PCC), an active optical cable and an active optical module for transmitting optical signals. In other alternative cases, the cable may also include an Ethernet cable, active optical cables (AOCs) or cable assembly with OSFP connectors. The semiconductor device may be a pluggable network interface device may comprise the male end portion of a direct attach cable assembly (DAC). The network connectors may each be configured to connect to a networking device of any type (e.g., QSFP, Direct Attach Copper, active optical cables (AOC), etc.), and may thus be dimensioned (e.g., sized and shaped) to mate with or otherwise connect to any corresponding networking device. The cable connector may be of any type (e.g., an AOC connector, Ethernet connector, Direct Attach Copper connector, Active Optical Module, or the like). A PCB is used to electrically connect electronic components using conductive pathways, or traces, etched from metal sheets. In many electronic systems, one or more very large-scale integrated circuit (“VLSI”) components is coupled to a host system printed circuit board (“PCB”). Such VLSI components may include, for example, central processing unit (“CPU) devices and graphics processing unit (“GPU”) devices. The PCB may hold at least one processing circuitry. The processing circuitry may comprise hardware, such as an application specific integrated circuit (ASIC). The processing circuitry may comprise an ASIC and/or may be capable of performing as a central processing unit (CPU), a graphics processing unit (GPU), a network interface controller (NIC), a data processing unit (DPU), or any other computing device in which with data is received and/or transmitted. Other non-limiting examples of the processing circuitry include an Integrated Circuit (IC) chip, a Central Processing Unit (CPU), a Graphics Processing Unit (GPU), a microprocessor, a Field Programmable Gate Array (FPGA), a collection of logic gates or transistors, resistors, capacitors, inductors, diodes, or the like. It should be appreciated that any appropriate type of electrical or optical component or collection of electrical or optical components may be suitable for inclusion in the processing circuitry. Numerous example embodiments will be described below in which a semiconductor package is mounted within a through hole of a PCB. Although PCBs having certain types and form factors appear in the drawings and the discussion, it should be noted that the illustrated and described types and form factors are provided by way of example only. Persons having skill in the art and having reference to this disclosure will readily appreciate that the same or similar apparatus and techniques may also be employed with PCBs having other types and form factors. For example, in some embodiments, the PCB to which the semiconductor package is mounted may comprise an add-in card, such as a PCIe card, that is configured to be coupled to a system board or motherboard of a host system. In other embodiments, the PCB to which the semiconductor package is mounted may be the system board or motherboard of the host system itself. Moreover, the system board or the motherboard may be associated with any type of host system. For example, the PCB may comprise the system board in a multi-node rack-mounted server in a data center, or it may comprise the motherboard of a workstation, desktop, laptop, or mobile device. Other embodiments are also possible.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU, GPU, DPUs, QPUs, or PPUs. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A connector comprising a lead section and a barrel section, wherein the barrel section is formed from a portion of the lead section and comprises a pin and a spring, wherein the pin is to extend from or retract into the barrel section based in part on an interface with the spring, and wherein the pin is to contact a surface contact pad on a circuit board to pass signals from the circuit board through the connector.

2. The connector of claim 1, wherein the connector is configured to be placed between a daughter board and a backplane or a midplane.

3. The connector of claim 1, wherein the pin and the spring form a single pogo pin feature within the connectors.

4. The connector of claim 1, wherein the connector is part of one or more of:
a differential signal connection, with the pin being one of a set of differential signal pins; or
an array of connectors forming a lead frame connector between the circuit board and a further circuit board or computing component.

5. The connector of claim 1, wherein the lead section is part of a lead pair for a set of differential signal pins and wherein the lead section comprises an insulation media between the lead pair.

6. The connector of claim 1, wherein the barrel section allows an electrical connection from the pin and through the barrel section to pass the signals from the circuit board through the connector.

7. The connector of claim 1, further comprises:
rigid insulation which is around the lead section and the barrel section to allow a rigid form factor for the connector.

8. The connector of claim 1, further comprises:
a second barrel section to couple, through the lead section, to the barrel section, wherein the second barrel section is coupled to a daughter board and the barrel section is to couple to a midplane or a backplane of a rack in a datacenter.

9. The connector of claim 1, further comprising:
parallel leads in the lead section and parallel barrels in the barrel section, wherein the parallel barrels comprise a further pin and a further spring, and wherein the pin and the further pin are to support or allow a differential signal therebetween; and
an array of the parallel leads to allow the connector to be part of a lead frame connector.

10. The connector of claim 1, wherein the pin comprises one or more of a copper alloy or gold plating, the barrel comprises one or more of a copper alloy or nickel plating, and the spring comprises stainless steel.

11. The connector of claim 1, wherein the lead section comprises an angled feature to allow a 90-degree angle of separation between the barrel section of the connector and another barrel section of the connector or of another connector.

12. A system for a lead frame connector, comprising:
a plurality of lead sections;
a plurality of barrel sections at individual ends of the plurality of lead sections, wherein individual ones of the plurality of barrel sections are formed from portions of respective ones of the plurality of lead sections, and wherein the plurality of lead sections and the plurality of barrel sections form an array of connectors of the lead frame connector; and
at least two pins and at least two springs within the individual ones of the plurality of barrel sections, wherein the at least two pins are to extend from or retract into the individual ones of the plurality of barrel sections based in part on an interface with respective ones of the at least two springs, and wherein the at least two pins are to support or allow a differential signal through the lead frame connector.

13. The system of claim 12, further comprising:
a midplane or backplane comprising a receiving connector; and
a daughter board comprising the lead frame connector, wherein the plurality of lead sections of the lead frame connector comprise angled features to allow a 90-degree angle of separation between the plurality of barrel sections at the individual ends of the plurality of lead sections, and wherein the lead frame connector is coupled to the receiving connector with the daughter board being at a 90-degree angle with respect to the midplane or the backplane.

14. The system of claim 12, further comprising:
rigid insulation which is around the lead section and the barrel section to allow a rigid form factor for the lead frame connector.

15. The system of claim 12, wherein the connector is part of an array of connectors forming a lead frame connector between a plurality of circuit boards or between a circuit board and a computing component.

16. A datacenter, comprising:
a midplane or a backplane comprising a plurality of surface contact pads for differential signals; and
one or more daughter boards coupled to the midplane or backplane through a lead frame connector, the lead frame connector comprising:
a plurality of connectors arranged in an array; and
lead sections and barrel sections in individual ones of the plurality of connectors, wherein individual ones of the barrel sections are formed from portions of respective ones of the lead sections, wherein the individual ones of the barrel sections comprise at least two pins and at least two springs, wherein the at least two pins are to extend from or retract into the individual ones of the barrel sections based in part on an interface with respective ones of the at least two springs, and wherein the at least two pins are to support or allow the differential signals through the lead frame connector to or from at least some of the plurality of surface contact pads.

17. The datacenter of claim 16, further comprising:
rigid insulation which is around the lead section and the barrel section to allow a rigid form factor for the lead frame connector.

18. The datacenter of claim 16, wherein the connector is part of an array of connectors forming a lead frame connector between the midplane or the backplane and the one or more daughter boards.

19. A method for connector for signaling, the method comprising;
forming a lead section according to a layout for the connector;
forming a barrel section from a portion of the lead section;
associating a pin and a spring within the barrel section;
allowing the pin to extend from or retract into the barrel section based in part on an interface with the spring; and
allowing the connector to be used for the signaling between at least two circuit boards or components of the circuit boards, wherein the pin is to contact a surface contact pad on at least one of the circuit boards to pass signals from the circuit board and through the connector.

20. The method of claim 19, further comprising one of:
providing the connector as part of plurality of connectors forming a lead frame connector, wherein the connector is part of a differential signal connection, with the pin being one of a set of differential signal pins from the plurality of connectors;
allowing an electrical connection from the pin and through the barrel section to pass the signals between the circuit boards through the connector. providing rigid insulation around the lead section and the barrel section to allow a rigid form factor for the connector; or
allowing an angled feature in the lead section for a 90-degree angle of separation between the barrel section of the connector and another barrel section of the connector or of another connector.
